(19) United States
(12) Patent Application Publication
(10) Pub. No.: US 2008/0134194 A1
(43) Pub. Date: Jun. 5, 2008

(54) Method for Dynamic Resource Allocation in Centrailized Base Stations

(75) Inventor: Sheng Liu, Zhejiang (CN)

Correspondence Address: PILLSBURY WINTHROP SHAW PITTMAN, LLP, P.O. BOX 10500, MCLEAN, VA, 22102, US

(73) Assignee: Utstarcim Telecom Co., Ltd., Hangzhou City (CN)

(21) Appl. No.: 11/573,664

(22) PCT Filed: Aug. 13, 2004
(86) PCT No.: PCT/CN04/00944

§ 371 Date: Aug. 17, 2007

(51) Int. Cl. G06F 9/50

(52) U.S. Cl. 718/105

(57) ABSTRACT

A method for realizing dynamic allocation of channel processing resources and load balancing in a centralized base station is disclosed, said centralized base station comprising a plurality of channel processing units independent of each other and remote radio frequency units connected to said channel processing units. The method comprises: dividing a plurality of cells under control of said centralized base station into a plurality of cell groups that are geographically adjacent and are centralized in the same regions different channel processing units performing channel processing of corresponding cell groups, respectively, wherein the channel processing units which are responsible for processing geographically adjacent cell groups are an adjacent channel processing unit for each other; determining a processing load amount of the respective channel processing units and traffic of the respective cells; and adaptively adjusting the cell groups for which the respective channel processing units are responsible for performing channel processing based on the determined processing load amount of the respective channel processing units and the determined traffic of the relevant cells, thereby balancing processing loads of the respective channel processing units. The method can effectively utilize the channel processing resources.

### FIELD OF TECHNOLOGY

The present invention relates to centralized base stations in a mobile communications system. In particular, the present invention relates to a method for dynamic resource allocation and load balancing control in a centralized base station system using remote radio frequency units (RRUs).

### BACKGROUND ART

1 Overview of Centralized Base Stations

In a mobile communications system, a base transceiver station (BTS) carries out transmission, reception and processing of wireless signals. A traditional BTS mainly consists of a base band processing subsystem, an RF subsystem and antennas, and one BTS can cover different cells via a plurality of antennas, as shown in FIG. 1(a); the BTSs are connected to a base station controller (BSC) or a radio network controller (RNC) via certain interfaces, respectively, thereby constituting a radio access network (RAN), as shown in FIG. 1(b).

FIG. 2 shows a system architecture of a centralized base station using RRUs. Compared with a traditional base station, this centralized base station using RRUs has many advantages: one macro-cell based on the traditional base station is allowed to be replaced with a plurality of micro-cells, so as to be well adapted to different wireless environments and to improve capacitance, coverage and other wireless performances of the system; owing to such a centralized structure, a soft handover is caused to be performed by a softer handover thereby to obtain extra processing gain; owing to such a centralized structure, expensive base band signal processing resources are caused to be a resource pool shared by a plurality of cells, thereby obtaining statistic multiplexing benefits and effectively reducing system costs. PCT patent No. WO9005432, titled “Communications System”, U.S. Pat. No. 5,657,374, titled “Cellular System with Centralized Base Stations and Distributed Antenna Units”, U.S. Pat. No. 6,324,391, titled “Cellular Communication with Centralized Control and Signal Processing”, China patent application No. CN1471331, titled “Mobile Communications Base Station System”, and U.S. patent application No. US20030171118, titled “Cellular Radio Transmission Apparatus and Cellular Radio Transmission Method”, etc. all reveal relevant implementing details of that technique.

As shown in FIG. 2, the centralized base station system using RRUs mainly consists of a central channel processing master unit (MU) 10 and a plurality of remote radio frequency units (RRUs) 20 that are provided in a centralized manner, and they are connected via a wideband transmit link or a network, whereas a BSC/RNC interface unit is responsible for carrying out processing of a user plane and a signalling plane of interfaces between the BTSs and the BSC RNC. The central channel processing master unit (MU) is mainly comprised of a channel processing resource pool, a signal routing allocating unit and other functionality units, wherein the channel processing resource pool is formed by stacking a plurality of channel processing units and performs base band signal processing and other jobs, and the signal routing allocating unit dynamically allocates channel processing resources based on differences in traffic of respective cells, so that the processing resources can be effectively shared by plural cells. The signal routing allocating unit, besides being realized inside the MU as shown in FIG. 2, can also be realized as a single device outside the MU. Each of the RRUs is mainly constituted of a transmit channel RF power amplifier, a receive channel low-noise amplifier, antennas and other functionality units. The links between the central channel processing master unit 10 and the RRUs typically utilize optical fibers, copper cables, microwaves and other transmission media; a signal transmission may take the forms of sampled digital signals or modulated analog signals; signals can be base band signals, intermediate frequency signals or RF signals.

It is easy to find that a primary advantage of the centralized base station system using RRUs lies in enabling the base band signal processing resources to be a resource pool shared by plural cells, thereby obtaining statistic multiplexing benefits and effectively reducing system costs. Thus, how to effectively perform allocation of the channel processing resources is a key point for the centralized base station.

2. Channel Processing Resources and Centralized Base Station Architecture

In a code division multiple access (CDMA) system, the base band signal processing resources mainly consist of a chip-level processing unit using a RAKE receiver or other enhanced receiving techniques such as multi-user detection (MUD) as a core, and a symbol-level processing unit using a channel CODEC processing as a core, wherein the symbol-level processing is closely related to user service types and rate relationships, whereas the chip-level processing is little affected by user service types and rate relationships but is primarily associated with the number of service channels.

In a large-scale base station system which supports multiple sectors and multiple carrier frequencies, a channel processing function section typically has two possible architectures, wherein one is realized by integrating chip-level processing units and symbol-level processing units on a single board, that is, the system consists of a plurality of channel processing modules the number of which can be configured; the other one is realized by providing chip-level processing units and symbol-level processing units on different boards, respectively, that is, the system consists of a plurality of chip-level processing modules and symbol-level processing modules the number of which can be configured. FIGS. 3 and 4 show typical implementing examples of the above two architectures.

In a typical example of the system architecture formed by integrating chip-level processing units and symbol-level processing units as shown in FIG. 3, the system consists of M independent channel processing modules, and the so-called “independent” indicates that these channel processing modules perform their respective channel processing tasks without any internal signal interconnection. Without internal signal interconnection, the design of the backboard bus of the system is caused to be greatly simplified, which is conducive to forming a large-scale centralized base station. The independence between the modules is not conducive to the effective utilization of system resources, but the prior-art solutions to the base band signal processing also have an all-software implementing solution based on a digital signal processor (DSP) or a structure formed by a plurality of arrays of micro-processing units for parallel processing. Owing to software flexibility in the processor resource scheduling, the deficiency of the structure with regard to the effective utilization of system resources is greatly lessened.

In a typical example of the system architecture, with chip-level processing units and symbol-level processing units separated, as shown in FIG. 4, the system consists of P chip-level processing modules and Q symbol-level processing modules, wherein the chip-level processing modules are independent of each other, that is, they perform their respective chip-level processing tasks without any internal signal interconnection. The chip-level processing rate is very high, so the internal signal interconnection between the chip-level processing modules will cause the system architecture complicated and it is hard to be applied in the large-scale centralized base station. On the other hand, due to a relatively low rate, the symbol-level processing modules allow the internal signal interconnection so as to realize the sharing of processing resources, so a symbol-level processing section can be regarded as a consecutive and single processing module.

Thus, the above-mentioned two typical implementing architectures have a problem that the channel processing resources are not continuous. In a large-scaled centralized base station, since each channel processing unit has a limited processing capability, when an RRU supported by the centralized base station are larger-scaled, it would be impractical to simultaneously exchange all the wireless signals of the RRU to each channel processing unit. In addition, since data flows of the wireless signals have a high rate, it is hard to simultaneously exchange all the wireless signals of the RRU to each channel processing unit, under restriction of the signal routing allocating unit and system complexity. Thus, the number of signals of the RRU which each channel processing unit can simultaneously process are always limited, that is, not all the wireless signals to which the RRU of the centralized base station corresponds can be simultaneously exchanged to a certain processing unit.

### SUMMARY OF THE INVENTION

An object of the present invention is to provide a method for dynamic resource allocation and load distribution in a centralized base station, thereby effectively utilizing channel processing resources.

According to the present invention, a method for realizing dynamic allocation of channel processing resources and load balancing in a centralized base station is provided, said centralized base station comprising a plurality of channel processing units independent of each other and remote radio frequency units connected to said channel processing units, said method comprising:

dividing a plurality of cells under control of said centralized base station into a plurality of cell groups that are geographically adjacent and are centralized in the same region, different channel processing units performing channel processing of corresponding cell groups, respectively, wherein the channel processing units which are responsible for processing geographically adjacent cell groups are an adjacent channel processing unit for each other;

determining a processing load amount of the respective channel processing units and traffic of the respective cells; and

adaptively adjusting the cell groups for which the respective channel processing units are responsible for performing channel processing based on the determined processing load amount of the respective channel processing units and the determined traffic of the relevant cells, thereby balancing processing loads of the respective channel processing units.

According to a basic conception of the present invention, only a signal allocation mode in which uplink and downlink signals of a certain cell are uniquely routed or exchanged to a certain channel processing unit is taken into account, without taking into account the case in which uplink signals of a certain cell are simultaneously allocated to two or more channel processing units. Thus, in the present invention, uplink and downlink wireless signals of any cell have and only have a corresponding channel processing unit responsible for channel processing. With regard to the typical examples of the channel processing system architectures as shown in FIG. 3 and FIG. 4, the problem of allocating channel processing resources in a centralized base station further boils down to the problem of optimally allocating wireless signals of respective RRUs of the centralized base station to the respective channel processing units of the centralized base station so as to perform channel processing of corresponding cells. In that, the above channel processing units, as for the channel processing system architecture as shown in FIG. 3, correspond to the respective channel processing modules, and as for the channel processing system architecture as shown in FIG. 4, corresponds to the chip-level processing modules (since the symbol-level processing section is a consecutive and single processing module, it does not have the above allocation problem and its internal resource scheduling is not considered in the present invention).

Need to explain that, the present invention, for illustration, is described by taking a CDMA system as an example. However, the basic conception, spirit, principles and methods of the present invention are still applicable to mobile communications systems of other systems such as FDMA, TDMA, OFDMA and the like.

### BRIEF DESCRIPTION OF THE ACCOMPANYING DRAWINGS

FIG. 1(a) shows a traditional BTS architecture;

FIG. 1(b) shows a traditional radio access network architecture;

FIG. 2 shows a conventional system architecture of a conventional centralized base station using an RRU;

FIG. 3 shows a conventional system architecture in which chip-level processing units and symbol-level processing units are integrated;

FIG. 4 shows a conventional system architecture in which chip-level processing units and symbol-level processing units are separated; and

FIG. 5 is a view showing geographical distribution of cells and allocation of channel processing resources in an embodiment of the method for realizing dynamic allocation of channel processing resources and load balancing in a centralized base station according to the present invention;

FIG. 6 is a view showing a load state shift of the channel processing units in the embodiment of the method for realizing dynamic allocation of channel processing resources and load balancing in a centralized base station according to the present invention;

FIG. 7(a), FIG. 7(b) and FIG. 7(c) are disintegration flow diagrams showing a cell group adjusting process I in the embodiment of the method for realizing dynamic allocation of channel processing resources and load balancing in a centralized base station according to the present invention;

FIG. 8 is an overall view showing the cell group adjusting process I as shown in FIG. 7(a), FIG. 7(b) and FIG. 7(c); and

FIG. 9 is a disintegration flow diagram showing a cell group adjusting process II in the embodiment of the method for realizing dynamic allocation of channel processing resources and load balancing in a centralized base station according to the present invention.

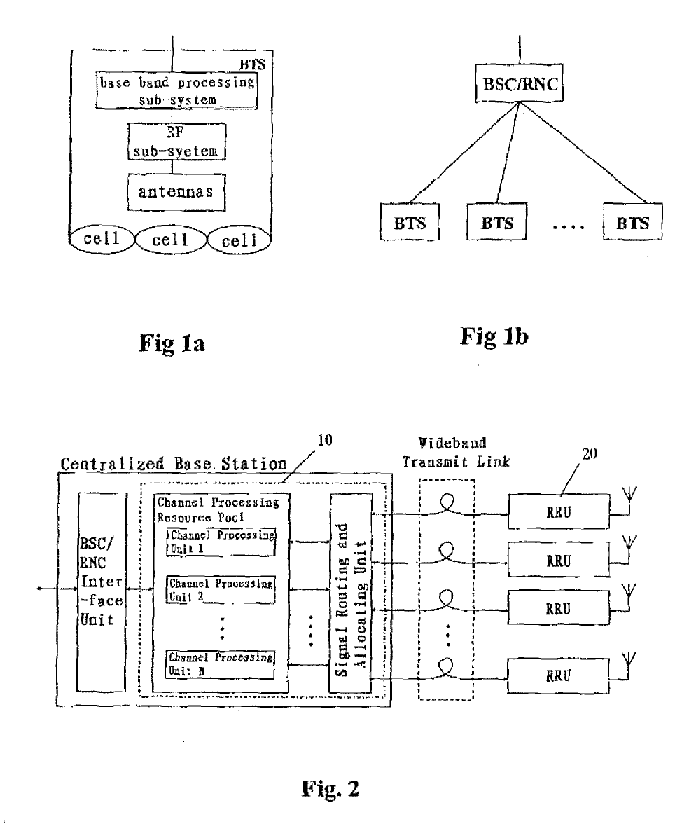

### BEST MODE FOR CARRYING OUT THE INVENTION

Referring to the drawings, an embodiment of the method for realizing dynamic allocation of channel processing resources and load balancing in a centralized base station according to the present invention will be described below in detail

1. Allocation of Channel Processing Resources and Load Balancing

According to the present invention, the allocation of channel processing resources in a centralized base station should enable cells, which cells correspond to radio links which each channel processing unit is responsible for processing, geographically adjacent and centralized in a certain region as far as possible. Thus, in the case where the RRU signal channel resources of the respective channel processing units are limited, it would facilitate enabling, as far as possible, the RRU wireless signals of cells in which macro-diversity branches are located to be exchanged to the same channel processing unit when a soft handover takes place, so as to realize a softer handover processing and improve wireless performances; and it would facilitate reducing, as far as possible, handover operations across the channel processing units caused during handovers of a mobile terminal among different cells. Therefore, in the present invention, the cells under control of the centralized base station are divided into a plurality of geographically adjacent cell groups, and different channel processing units perform channel processing of corresponding cell groups. Correspondingly, the channel processing units responsible for processing the geographically adjacent cell groups are mutually called adjacent channel processing units. In cells within a cell group which a certain channel processing unit corresponds to, the geographically adjacent cells within cell groups which all the adjacent channel processing units of the channel processing unit correspond to are called edge cells of the cell group which the channel processing unit corresponds to.

When the adopted mobile communication system supports the soft handover technique, simultaneously processing all the macro-diversity branches of one mobile terminal in the same channel processing unit will facilitate reducing consumption of system processing units and will facilitate improving coverage, capacitance and other wireless performances. Even if the adopted mobile communication system, such as a CDMA system in a TDD (Time Division Duplex) mode, does not support the cell soft handover, if the channel processing of radio links of a mobile terminal is still performed in the same channel processing unit when the mobile terminal performs handovers among different cells, it can reduce transport operations of context information associated with the mobile terminal among the different channel processing units, and reduce operations relating to parameter configuration and operations performed in new channel processing units, thereby simplifying system complexity and facilitating improvement of system stability and reliability.

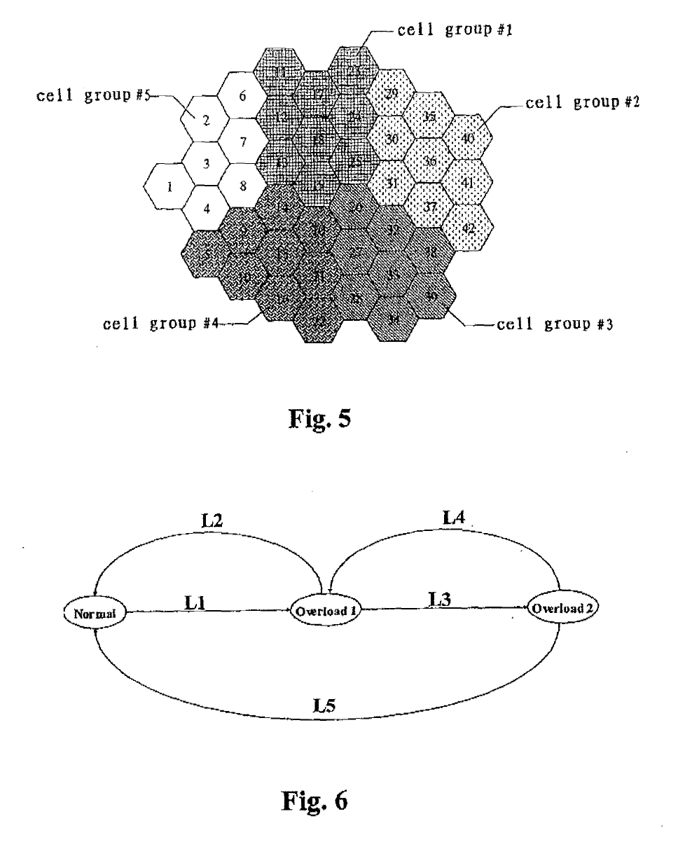

FIG. 5 shows an example in which channel processing resources of a centralized base station are allocated according to geographical distribution of cells, in the embodiment according to the present invention. The centralized base station includes five relatively independent channel processing units which are respectively responsible for channel processing tasks of five geographically adjacent cell groups #1-5 shown in FIG. 5, wherein the channel processing unit #1 is adjacent to the channel processing units #2, #3, #4 and #5, the channel processing unit #2 is adjacent to the channel processing units #1 and #3, the channel processing unit #3 is adjacent to the channel processing units #1, #2 and #4, the channel processing unit #4 is adjacent to the channel processing units #1, #3 and #5, and the channel processing unit #5 is adjacent to the channel processing units #1 and #4.

According to the present invention, allocation of channel resources and load balancing control in the centralized base station is mainly dependent on the processing load amount of the respective channel processing units and traffic of the respective cells, wherein the processing load amount of a channel processing unit can be typically represented by an absolute amount and a percentage. When the absolute amount is used for representation, it is possible to utilize the number of equivalence service channels (typically using voice service channels) processed by the channel processing unit for representation (the maximum value, i.e., the total number of the equivalence service channels which the channel processing units is capable of processing, is a known quantity), while the traffic of a cell is also represented by the number of the equivalence service channels; the processing load amount of the channel processing unit and the traffic of the cell are represented using the percentage as follows:

Processing load amount of a channel processing unit (percentage)=the number of equivalence service channels processed by the channel processing unit/the total number of equivalence service channels which the channel processing unit is capable of processing;

Traffic of a cell (percentage)=traffic of the cell represented by the number of equivalence service channels/the total number of equivalence service channels which the channel processing unit is capable of processing.

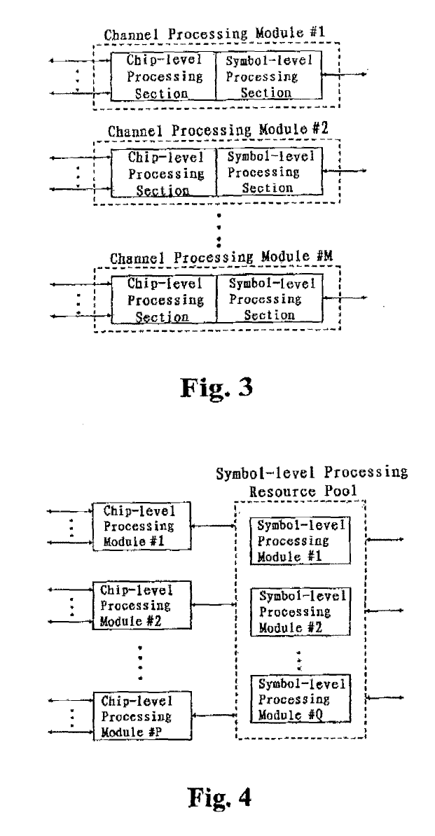

Since the processing capability of the channel processing units is mainly restricted by chip-level processing unit resources of the channel processing units (as for the channel processing system architecture shown in FIG. 4), or restricted by both chip-level processing unit resources and symbol-level processing unit resources (as for the channel processing system architecture as shown in FIG. 3), the maximum processing capability of the channel processing units, i.e., the total number of equivalence service channels which the channel processing units are capable of processing, is decided by them and known by the system. In addition, in order to make the allocation process of channel processing resources stable and convergent, the processing load amount of said channel processing units and the traffic of the respective cells typically are results of a smooth filtering or results of a pre-filtering within a period of time. Said smooth filtering operation typically includes IIR (Infinite Impulse Response) smooth filtering, arithmetic average or weighted average, and other processing modes, and said pre-filtering typically includes an IIR prediction/tracking filter and other processing modes.

According to the present invention, in the allocation of channel processing resources and load balancing control in the centralized base station, the processing load amount of the respective channel processing units and the traffic of the respective cells are recorded and a statistical processing thereof is performed, and cell groups for which the respective channel processing units are responsible for performing channel processing are adaptively adjusted according to the processing load amount of the respective channel processing units and the traffic of relevant cells so as to balance the load of the respective channel processing units, thereby achieving the object of maximizing resource usage rate and minimizing blocking probability. In a preferred embodiment of the method according to the present invention, said adaptively adjusting the cell groups for which the respective channel processing units are responsible for performing channel processing should be performed based on making, as far as possible, the cells which each channel processing unit is responsible for processing, geographically adjacent and centralized in a certain region. The reasons have been described in the above, that is, facilitating realizing softer handover processing to improve wireless performances, and facilitating reducing, as far as possible, handover operations across the channel processing units caused during handovers of the mobile terminal among different cells.

In addition, since the load allocation associated with the respective channel processing units is performed with a cell as a unit, the centralized base station supports handover operations of a cell channel processing task among the channel processing units. The handover operations of the cell channel processing task require all the context information and states associated with the cell to be transported from a source channel processing unit to a destination channel processing unit, so the occurrence frequency of the handover operations had better be reduced as much as possible in the allocation of channel resources and load balancing control process according to the present invention, thereby facilitating reduction of system control overhead and system complexity and facilitating improvement of system stability and reliability.

According to the present invention, in order to achieve resource allocation and load balancing in the centralized base station, a plurality of cells under control of said centralized base station are divided into a plurality of cell groups which are geographically adjacent and centralized in the same region, and different channel processing units respectively perform channel processing of corresponding cell groups. In the real-time running process of the centralized base station, a real-time statistics of the processing load amount of the channel processing units and the traffic of the respectively cells is carried out, and the respective channel processing units are monitored at any time to determine whether they falls into a situation of processing overload. Once a certain channel processing unit falls into the situation of processing overload, a corresponding processing is immediately performed, and the processing load of the channel processing unit is shared by other channel processing units so as to realize the load balancing among the respective channel processing units.

According to the present invention, in order to determine whether a processing load of a certain channel processing unit is overloaded, one or more threshold values may be set in advance, and a determination is made on whether the processing load of each channel processing unit exceeds the set threshold. Setting a plurality of threshold values in advance facilitates dividing the overload degree of the channel processing units into different degrees or levels so as to take different processing measures. Meanwhile, the mode that a load sharing processing is performed on the overloaded channel processing unit is carried out with a cell as a unit, and the size of a cell group for which the overloaded channel processing unit is responsible for channel processing is reduced, while the cells separated from the cell group thereof join a cell group for which a channel processing unit that shares the load with the overloaded channel processing unit is responsible for performing channel processing. Moreover, the load sharing of the channel processing unit further requires making, as far as possible, the cells which each channel processing unit is responsible for processing, geographically adjacent and centralized in a certain region. Thus, in the load sharing operation of the channel processing unit as described above, the load of overloaded channel processing unit should be shared in preference by an adjacent channel processing unit of the overloaded channel processing unit. Only when the overload degree of the overloaded channel processing unit becomes quite serious and the processing load of the adjacent channel processing unit thereof is likewise, will a non-adjacent processing unit perform the load sharing processing. Additionally, once the processing load of the overloaded channel processing unit and of the adjacent channel processing unit thereof become lighter, the cells processed by the non-adjacent channel processing unit for load sharing, geographically non-centralized and scattered in an isolated manner should be re-put under the processing of the overloaded channel processing unit or the adjacent channel processing unit thereof.

2. Preferred Method for Allocation of Channel Processing Resources and Load Balancing Control

As a preferred embodiment of the present invention, the present invention provides a simple and effective method for allocation of channel processing resources. In the embodiment, three states, i.e., a Normal state, an Overload-1 state and an Overload-2 state, as shown in FIG. 6, are defined in light of difference in load status of each channel processing unit.

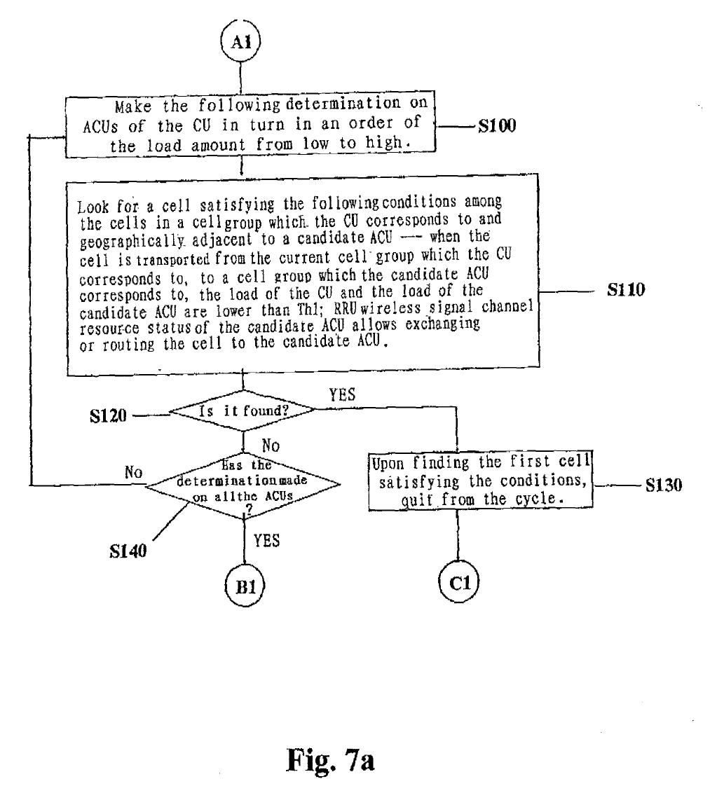

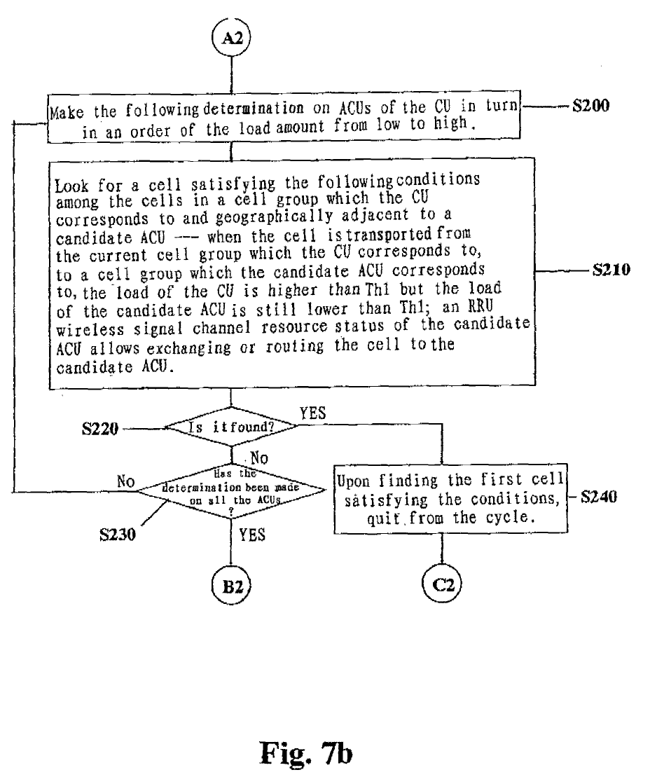

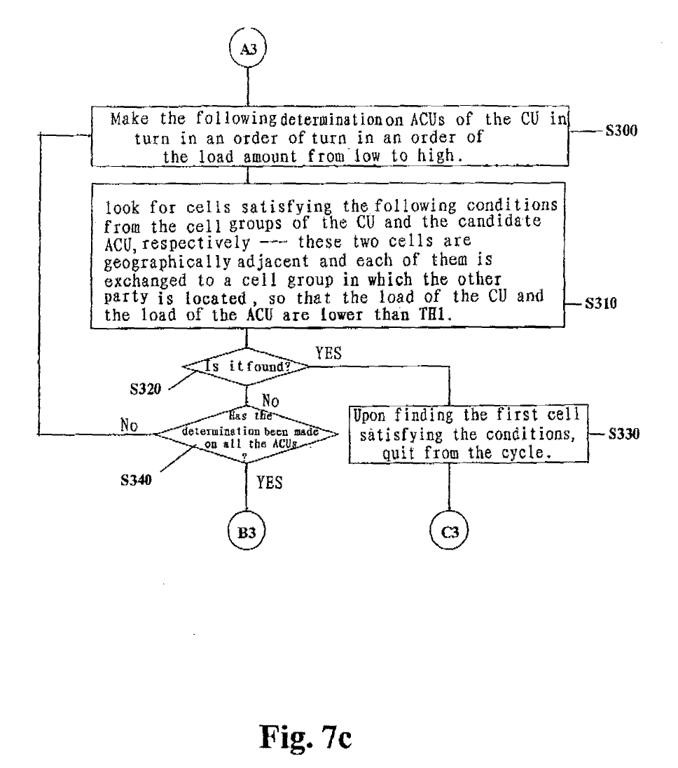

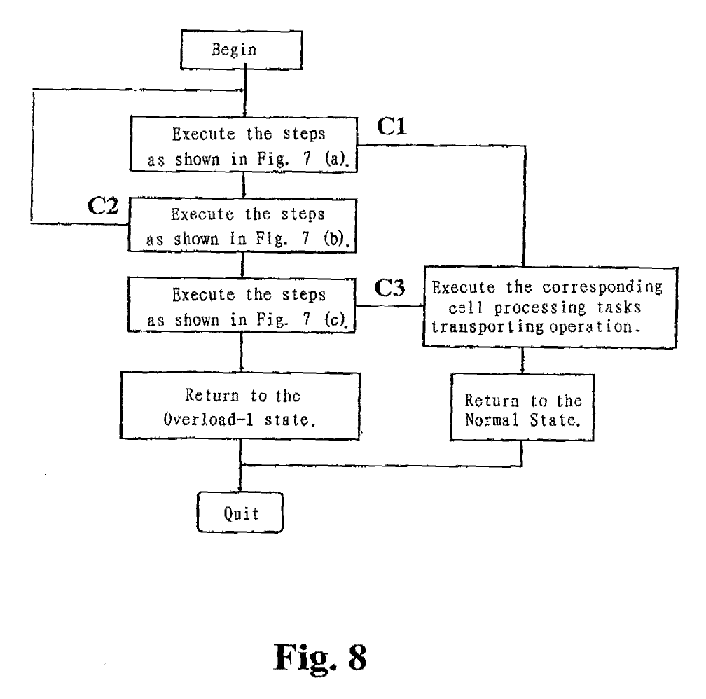

When a load of a channel processing unit becomes lower than a threshold value Th1, the channel processing unit is in the Normal state. When its load exceeds the threshold value Th1 for a period of time lag TLI, the channel processing unit is shifted to the Overload-1 state (L1) and immediately triggers a cell group adjustment process I as shown in FIG. 7 and FIG. 8. If the load sharing is successfully achieved after the adjustment and the load of the channel processing unit is reduced below the threshold value Th1, the channel processing unit will return to the Normal state (L2) or remain otherwise in the Overload-1 state.

When a certain channel processing unit is in the Overload-1 state, the cell adjustment process I is performed at regular time by period P1. If the load sharing is successfully achieved and the load is reduced below the threshold value Th1, the channel processing unit will return to the Normal state (L2) or remain otherwise in the Overload-1 state; alternatively, before the next cell group adjustment process I is triggered at regular time, if the load of the channel processing unit is reduced back below the threshold value Th1 due to traffic reduction of the cell group thereof, the channel processing unit will immediately return to the Normal state (L2).

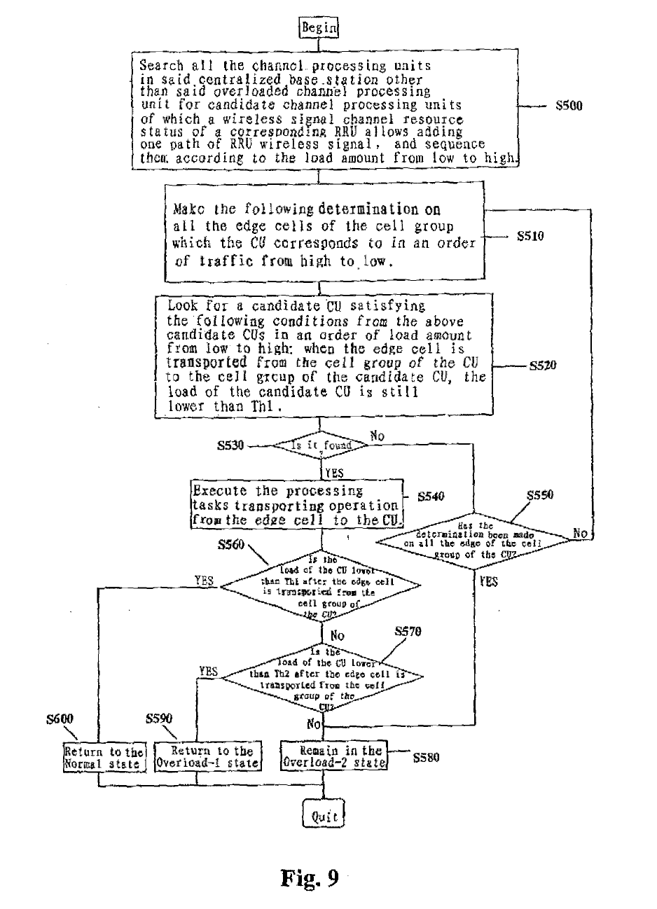

When a certain channel processing unit is in the Overload-1 state, once a load thereof exceeds a threshold value Th1 for a period of time lag TL2, then the cannel processing unit is shifted to an Overload-2 state (L3) and immediately triggers a cell group adjustment process II as shown in FIG. 9. If this process causes the load to be reduced below the threshold value Th1, the channel processing unit will return to the Normal state (L5), and when the load is reduced between the threshold values Th1 and Th2, the channel processing unit will return to the Overload-1 state (L4) or remain otherwise in the Overload-2 state. When a certain channel processing unit is in the Overload-2 state, the cell group adjustment process II will also be performed at regular time by period P2. If this process causes the load to be reduced below the threshold value Th1, the channel processing unit will return to the Normal state (L5), and when the load is reduced between the threshold values Th1 and Th2, the channel processing unit will return to the Overload-1 state (L4) or remains otherwise in the Overload-2 state. Before the next cell group adjustment process II is triggered at regular time, if the load of the channel processing unit is reduced back between the threshold values Th1 and Th2 due to traffic reduction of the cell group thereof, the channel processing unit will return to the Overload-1 state (L4), and when the load is reduced back below the threshold value Th1, the channel processing unit will immediately return to the Normal state (L5).

In this process, the Overload-1 state and the Overload-2 state reflect differences in serious degree of an overload of a channel processing unit, so the load sharing methods for these two states are also different, namely, respectively adopting the cell group adjustment processes I and II. The cell group adjustment process I ensures the cells which each channel processing unit is responsible for processing to be still geographically adjacent and centralized in the same region, after the cell group adjustment. However, when the channel processing unit has an excessive load and an effective load sharing fails to be realized by adopting the cell group adjustment process I, the cell group adjustment process II allows any other channel processing unit to share processing loads of edge cells of the cell group which the channel processing unit corresponds to, so that the maximization of resource usage rate and the minimization of blocking probability can be guaranteed. Nevertheless, since the cell group adjustment process II only allows the sharing of the processing load of the edge cells of the cell group of the channel processing unit, the principle that the above cells are geographically adjacent and centralized avoids being violated. Meanwhile, as for “isolated” cells caused by the cell group adjustment process II, this process adopts an “absorbing” process to prevent the above principle from being violated (as described below).

2.1 Cell Group Adjustment Process I

As described in the above, the cell group adjustment process I ensures the cells which each channel processing unit is responsible for processing to be still geographically adjacent and centralized in the same region, after the cell group adjustment, and this is realized in a manner that an adjacent channel processing unit thereof shares the processing load of the edge cells of the cell group which the channel processing unit corresponds to. First of all, the adjacent channel processing unit which bears the load sharing is still in a Normal state after sharing the load, that is, the load is lower than Th1, and in the case where the above premise is guaranteed, three simplest load sharing situations exist as follows:

(1) the load of the overloaded channel processing unit is lower than Th1 after the processing load of one edge cell is reduced;

(2) the load of the overloaded channel processing unit is lowered but still higher than Th1 after the processing load of one edge cell is reduced; and

(3) the load of the overloaded channel processing unit is lower than Th1 after it exchanges the processing load of one edge cell with a certain adjacent channel processing unit.

For the sake of simple implementation, the above-mentioned three simple load sharing modes are adopted in preference in the cell group adjustment process I, as shown in FIGS. 7(a), 7(b) and 7(c), respectively. However, the present invention is not limited to these modes but can adopt other complicated modes for implementation. Moreover; for the sake of clarity, a CU and an ACU are used to represent a channel processing unit and an adjacent channel processing unit, respectively, in the following description.

The process shown in FIG. 7 (a) begins with the processing of an ACU of the CU which has the minimum load amount (S100). Once a cell satisfying the following conditions is found among the cells in a cell group which the CU corresponds to and geographically adjacent to a candidate ACU—when the cell is transported from the current cell group which the CU corresponds to, to a cell group which the candidate ACU corresponds to, the load of the CU and the load of the candidate ACU are lower than Th1; an RRU wireless signal channel resource status of the candidate ACU allows exchanging or routing the cell to the candidate ACU—the process immediately quits from a cycle process (S110-S140, C1); otherwise, the above processing are carried out in turn in an order of the load amount from low to high, until the cell satisfying the above conditions cannot be found in all the ACUs of the CU (B1).

The process shown in FIG. 7 (b) also begins with the processing of an ACU of the CU which has the minimum load amount (S200). Once a cell satisfying the following conditions is found among the cells in a cell group of the CU and geographically adjacent to a candidate ACU—when the cell is transported from the current cell group which the CU corresponds to, to a cell group which the candidate ACU corresponds to, the load of the CU is still higher than Th1, but the load of the candidate ACU is still lower than Th1; an RRU wireless signal channel resource status of the candidate ACU allows exchanging or routing the cell to the candidate ACU—the process immediately quits from a cycle process (S210-S240, C2); otherwise, the above processing are carried out in turn in an order of the load amount from low to high, until the cell satisfying the above conditions cannot be found in all the ACUs of the CU (B2).

The process shown in FIG. 7 (c) also begins with the processing of an ACU of the CU which has the minimum load amount (S300). If cells satisfying the following conditions are found in cell groups of the CU and the candidate ACU—these two cells are adjacent, and if each of them is transported to a cell group where the other party is located, the load of the CU and the load of the candidate ACU are all lower than Th1—the process immediately quits from a cycle process (S310-S340, C3); otherwise, the above processing are carried out in turn in an order of the load amount from low to high, until the cells satisfying the above conditions cannot be found in all the ACUs of the CU (B3).

The cell group adjustment process I shown in FIG. 8 is a combination process of the above three load sharing processes. First of all, the load sharing processing shown in FIG. 7(a) is executed, and if not successful, the processing shown in FIG. 7 (b) is then executed. If the processing shown in FIG. 7 (b) is effective, it indicates that the overloaded channel processing unit has an excessive load, so that its load still cannot be reduced below the threshold Th1 by decreasing a processing load of one edge cell, so it is necessary to further perform the load sharing processing. Since the edge cells of the adjusted cell group are changed, the process returns to the process as shown in FIG. 7 (a) to re-perform the load sharing processing; if still not successful, it indicates an adjacent channel processing unit of the overloaded channel processing unit has a too great load to directly bear a processing load of one edge cell of the overloaded channel processing unit, so it is possible to try the third load sharing mode as shown in FIG. 7 (c), that is, the overloaded channel processing unit and an adjacent channel processing unit thereof exchange a processing load of one edge cell, so that the channel processing unit and the adjacent channel processing unit both have a load lower than Th1.

2.2 Cell Group Adjustment Process II

As described in the foregoing, when the cell group adjustment process I is adopted, since a channel processing unit has a too heave load to realize an effective load sharing, it is possible to adopt the cell group adjustment process II. Thus, any other channel processing unit is allowed to share a processing load of an edge cell of a cell group which the channel processing unit corresponds to, thereby guaranteeing the maximization of resource usage rate and the minimization of blocking probability.

As shown in FIG. 9, first of all, all CUs in the centralized base station other than this CU are searched for candidate CUs, the corresponding RRU wireless signal channel resource status of which candidate CUs allows increasing one path of RRU wireless signals, and they are sequenced according to the load amount from low to high (S500). Then, the following processing begins with the edge cell having the maximum traffic among the edge cells of a cell group which the CU corresponds to: searching for candidate CUs satisfying the following conditions in the above set of candidate CUs in turn in an order of the load amount from low to high—after the edge cell is transported from the cell group of the CU to the cell group of the candidate CU, the candidate CU still has a load less than Th1 (S510, S520). If the candidate CU fails to be found, the above processing are performed in turn in an order of the traffic amount from high to low, until none candidate CUs satisfying the above conditions can be found for all the edge cells of the cell group which the CU corresponds to (S530, S550, S580). This indicates the cell group adjustment process II cannot succeed in the load sharing, so the overloaded channel processing unit will still remain in the Overload-2 state.

Once a candidate CU satisfying the above conditions is found in the above described processing cycle of a certain edge cell, the process will immediately quit from the cycle and execute a processing task transporting operation (S530, S540) from the edge cell to the CU. If the CU still has a load less than Th1 after the edge cell is transported away from the cell group of the CU, the CU will return to the Normal state (S560, S600), and if the load is reduced between Th1 and Th2, the CU will return to the Overload-1 state (S560, S570, S590); otherwise, the CU will still remain in the Overload-2 state (S560, S570, S580).

2.3 Absorbing Process of Isolated Cells

As described in the above, since the cell group adjustment process II only allows sharing of the processing load of the edge cells of the cell group which the overloaded channel processing unit corresponds to, this process, as for the channel processing unit, avoids violating the principle that the cells are geographically adjacent and centralized. However, the adoption of the cell group adjustment process II will cause the occurrence of said “isolated cells”. In fact, in the cell group adjusting process II, an isolated cell is separated from the edge cells of the cell group which the overloaded channel processing unit corresponds to and joins a cell group of a certain channel processing unit which shares the processing load of the overloaded channel processing unit. Thus, the present invention adopts an “absorbing” process to prevent the above principle from being violated.

The absorbing process is as follows: monitoring load situations of all the channel processing units which correspond to cell groups geographically adjacent to said edge cells; once a processing load of one certain channel processing unit among these channel processing units is reduced lower than the threshold value Th1 even if said edge cells are absorbed, transporting said edge cells from a cell group of an original channel processing unit thereof to a cell group of the channel processing unit, and the channel processing unit being responsible for processing tasks of said edge cells.

The respective technical solutions of the present invention are described in the above with reference to the specific embodiments. However, those skilled in the art know, various improvements or transformations of the present invention can be further made, without departing from the principle and spirit of the present invention. The scope of the present invention is merely determined by the enclosed claims.

What is claimed is:

1. A method for realizing dynamic allocation of channel processing resources and toad balancing in a centralized base station, said centralized base station comprising a plurality of channel processing units independent of each other and remote radio frequency units connected to said channel processing units, said method comprising the following steps:
dividing a plurality of cells under control of said centralized base station into a plurality of cell groups that are geographically adjacent and are centralized in the same region, different channel processing units performing channel processing of corresponding cell groups, respectively, wherein the channel processing units which are responsible for processing geographically adjacent cell groups are an adjacent channel processing unit for each other;
determining a processing load amount of the respective channel processing units and traffic of the respective cells; and
adaptively adjusting the cell groups for which the respective channel processing units are responsible for performing channel processing based on the determined processing load amount of the respective channel processing units and the determined traffic of the relevant cells, thereby balancing processing loads of the respective channel processing units.

2. A method according to claim 1, wherein said step of adaptively adjusting the cell groups for which the respective channel processing units are responsible for performing channel processing further comprises the sub-steps of:
classifying the processing loads of the respective channel processing units based on a determination result in said determining step, thereby obtaining load states of the respective channel processing units; and
adjusting, when said channel processing unit is in an overload state, a processing load of said overloaded channel processing unit according to the corresponding overload state, thereby realizing load balancing of the respective channel processing units.

3. A method according to claim 2, wherein said overload state comprises a first overload state and a second overload state, the second load state being an overload state more serious than the first overload state, and wherein said method further comprises the steps of:
adjusting, when said channel processing unit has a processing load in the first overload state, the processing load of said overloaded channel processing unit by a channel processing unit adjacent to said overloaded channel processing unit sharing a processing load of an edge cell of a cell group which the overloaded channel processing unit corresponds to; and
adjusting, when said channel processing unit has a processing load in the second overload state, the processing load of said overloaded channel processing unit by any other channel processing unit sharing a processing load of an edge cell of a cell group which the overloaded channel processing unit corresponds to.

4. A method according to claim 3, wherein said method further comprises the steps of:
presetting a first threshold value and a second threshold value greater than said first threshold value, wherein said first threshold value represents the first overload state of the respective channel processing units, and said second threshold value represents the second overload state of the respective channel processing units;
said channel processing unit, when its processing load is greater than or equal to the first threshold value for a first predetermined time period, being shifted to the first overload state, and performing, on said channel processing unit, the processing load adjustment corresponding to the first overload state at the same time, if its processing load is reduced below the first threshold value, said channel processing unit returning to a normal load state or remaining otherwise in the first overload state, and said processing load adjustment being performed in a first time cycle; and
said channel processing unit, when it is in the first overload state and its load is greater than or equal to the second threshold value for a second predetermined time period, being shifted to the second overload state, and performing, on said channel processing unit, the processing load adjustment corresponding to the second overload state at the same time, if its processing load is reduced below the first threshold value, said channel processing unit returning to a normal load state, if its processing load is reduced to within the first threshold value and the second threshold value, said channel processing unit returning to the first overload state or remaining otherwise in the second overload state, and said processing load adjustment being performed in a second time cycle.

5. A method according to claim 4, wherein the process of the processing load adjustment corresponding to the first overload state comprises the steps of:
performing, on said overloaded channel processing unit in the first overload state, a first cell decreasing processing of decreasing one edge cell, thereby adjusting the load state of the overloaded channel processing unit;
performing, on said overloaded channel processing unit, a second cell decreasing processing of decreasing one edge cell instead of the first cell decreasing processing, if said first cell decreasing processing fails to adjust the processing load of the overloaded channel processing unit and a processing load of an adjacent channel processing unit which shares the processing load of the decreased edge cell below the first threshold value, and continuing to perform, on said overloaded channel processing unit, the first cell decreasing processing, if the processing load of the overloaded channel processing unit, subsequent to the second cell decreasing processing, is reduced but still greater than or equal to the first threshold value and the processing load of the adjacent channel processing unit which accepts the decreased edge cell is lower than the first threshold value;
performing the following processing instead of the second cell decreasing processing, if the processing load of the overloaded channel processing unit and the processing load of the adjacent channel processing unit, subsequent to a combination of the first cell decreasing processing and the second cell decreasing processing, still fail to be adjusted lower than the first threshold value, or if the second cell decreasing processing fails to make the processing load of the overloaded channel processing unit reduced while the processing load of the adjacent channel processing unit lower than the first threshold value; and
performing a cell exchanging processing, so that the overloaded channel processing unit and its adjacent channel processing unit exchange a processing load of one edge cell, and if said cell exchanging processing fails to make the load of the overloaded channel processing unit and the load of the adjacent channel processing unit lower than the first threshold value, causing said overloaded channel processing unit still in the first overload state.

6. A method according to claim 5, wherein said first cell decreasing processing includes the steps of:
when a corresponding edge cell of a cell group which said overloaded channel processing unit corresponds to is transported from said cell group to a cell group which the adjacent channel processing unit sharing the processing load of the edge cell corresponds to, if the processing load of said overloaded channel processing unit and the processing load of said adjacent channel processing unit are lower than said first threshold value, and a wireless signal channel resource status of an RRU of said adjacent channel processing unit allows exchanging or routing said edge cell to said adjacent channel processing unit, said adjacent channel processing unit sharing the processing load of said corresponding edge cell.

7. A method according to claim 5, wherein said second cell decreasing processing includes the steps of:
when a corresponding edge cell of a cell group which said overloaded channel processing unit corresponds to is transported from said cell group to a cell group which the adjacent channel processing unit sharing the processing load of the edge cell corresponds to, if the load of said overloaded channel processing unit is still higher than the first threshold value and the processing load of said adjacent channel processing unit is still lower than said first threshold value, and a wireless signal channel resource status of an RRU of said adjacent channel processing unit allows exchanging or routing said corresponding edge cell to said adjacent channel processing unit, said adjacent channel processing unit sharing the processing load of said corresponding edge cell.

8. A method according to claim 5, wherein said cell exchanging processing includes the steps of:
if edge cells can be found from the cell group which said overloaded channel processing unit corresponds to and from the cell group which said adjacent channel processing unit sharing the processing load of the edge cell corresponds to, that is, these two cells are adjacent and when each of them is transported to a cell group where the other party is located, the load of said overloaded channel processing unit and the load of said adjacent channel processing unit are made lower than the first threshold value, said overloaded channel processing unit and said adjacent channel processing unit exchanging a processing load of said edge cell, thereby making the load of said overloaded channel processing unit and the load of said adjacent channel processing unit lower than the first threshold value.

9. A method according to claim 4, wherein the process of the processing load adjustment corresponding to the second overload state comprises the sub-steps of:
searching all the channel processing units in said centralized base station other than said overloaded channel processing unit for a candidate channel processing unit, wherein a wireless signal channel resource status of a corresponding RRU of which candidate channel processing unit allows adding one path of RRU wireless signals,
performing the following processing on one edge cell having the maximum traffic among edge cells of the cell group which said overloaded channel processing unit corresponds to, in an order of traffic from high to low:
looking for a candidate channel processing unit satisfying the following conditions from the above set of the candidate channel processing units in an order of load amount from low to high: after said edge cell is transported from the cell group of said channel processing unit to a cell group of the candidate channel processing unit, the load of said candidate channel processing unit being still lower than said first threshold value, and
sharing the processing load of said edge cell by said found candidate channel processing unit.

10. A method according to claim 9, further comprising the step of:
monitoring load statuses of all the channel processing units corresponding to cell groups geographically adjacent to said edge cell, and once a processing load of one certain channel processing unit among these channel processing units is reduced lower than the first threshold value even if said edge cell is absorbed, transporting said edge cell from a cell group of its original channel processing unit to the channel processing unit, and the channel processing unit being responsible for processing tasks of said edge cell.

11. A method according to any one of claims 1-10, wherein the processing load amount of said channel processing unit and the traffic of the corresponding cells are represented by the number of equivalence service channels processed by the channel processing unit, or represented by a percentage of the number of said equivalence service channels to the total number of equivalence service channels which the channel processing unit is capable of processing.

12. A method according to any one of claims 1-10, wherein in said determining step, the processing load amount of the channel processing unit and the traffic of the respective cells are determined based on results of a smooth filtering or results of a pre-filtering during a period of time.

13. A method according to claim 12, wherein said smooth filtering comprises infinite impulse response IIR smooth filtering, arithmetic average or weighted average, and said pre-filtering comprises an IIR prediction/tracking filter.
